(19) United States
(12) Patent Application Publication
(10) Pub. No.: US 2026/0317586 A1
(43) Pub. Date: Oct. 15, 2026

(54) FIREPROOF ADHESIVE TAPE

(71) Applicant: SIKA TECHNOLOGY AG, Baar (CH)

(72) Inventors: Ramon BUCHER, Kerns (CH); Sebastien DEBETENCOURT, Montfort L'Amaury (FR); Adrian MICHEL, Kerns (CH)

(73) Assignee: SIKA TECHNOLOGY AG, Baar (CH)

(21) Appl. No.: 19/491,484

(22) PCT Filed: Sep. 19, 2024
(86) PCT No.: PCT/EP2024/076330

§ 371 Date: Dec. 9, 2025

(30) Foreign Application Priority Data
Sep. 21, 2023 (EP) 23198944.3

(51) Int. Cl. C09J 7/29; C09J 5/00; C09J 123/22; E04D 5/14

(52) U.S. Cl. CPC C09J 7/29; C09J 5/00; C09J 123/22; C09J 2301/302; C09J 2400/16; C09J 2467/00; E04D 5/148

(57) ABSTRACT

An adhesive tape including: i) a metal film having a thickness of not more than 100 μm, ii) a polymeric support layer having first and second major surfaces, iii) a pressure sensitive adhesive layer, and iv) optionally a release liner covering an outer major surface of the pressure sensitive adhesive layer facing away from the polymeric support layer, wherein the polymeric support layer is arranged between the metal film and the pressure sensitive adhesive layer.

### TECHNICAL FIELD

The invention relates to the field waterproofing of below and above ground building constructions. Particularly, the invention relates to self-adhesive fireproof tapes, which are adhered to a surface of a substrate to delay or stop the spread of flames.

### BACKGROUND OF THE INVENTION

In the field of construction, polymeric sealing elements that are often referred to as membranes, panels, sheets, or liners are used to protect underground and above ground constructions, such as base slabs, walls, floors, basements, tunnels, wet rooms, building facades, flat and low-sloped roofs, landfills, water-retaining structures, ponds, and dikes against penetration of water, moisture, volatile organic compounds, or harmful gases. The membranes are typically delivered to a construction site in form of rolls, transferred to the place of installation, unrolled, and adhered or mechanically fastened to the substrate to be sealed.

Waterproofing membranes are applied, for example, to prevent ingress of water through cracks that develop in the concrete structure due to building settlement, load deflection or concrete shrinkage. They are also used in heavy loaded commercial and residential wet rooms, shower rooms or therapy rooms in hospitals, and on balconies, terraces and in swimming pools to protect the structures against penetration of water. Roofing membranes are used for sealing of flat and low-sloped roof structures to prevent leaks and to take water off the roof. Waterproofing tapes comprising a polymeric carrier layer are also used for sealing and waterproofing of construction gaps in building facades, for example gaps between a building structure and window or curtain wall components.

Commonly used materials for membranes and tapes include plastics, particularly thermoplastics such as plasticized polyvinylchloride (p-PVC), thermoplastic olefins (TPE-O, TPO), and elastomers such as ethylene-propylene diene monomer (EPDM) rubber. Bituminous materials are also used since they provide good resistance against environmental factors combined with relatively low costs compared to thermoplastic polymer materials. Bitumen compositions are typically modified with synthetic polymers to improve resistance to UV-radiation, toughness, and flexibility at low temperatures.

A common disadvantage of the plastic materials is their inherently low fire resistance properties. The limiting oxygen index (LOI) of most polymeric materials is less than 25%, which make them flammable or combustible. Generally, construction products composed of polymeric materials must fulfill certain fire resistance requirements, i.e., to achieve a specific “fire rating classification”. The required classification depends on the type of the product. For example, polymeric sheets used in the external facade, such as breather membranes and vapor control layers, have a different fire rating requirement than roofing membranes used for covering a flat roof structure. In Europe, the requirements for fire safety in buildings have been increased after the Grenfell Tower disaster in 2017.

Flame retardant additives can be added to polymer blends to improve their fire resisting/retarding properties to enable their use in various applications. Commonly used flame retardants for waterproofing membranes and tapes include metal hydroxides, particularly alumina trihydrate (ATH), precipitated aluminum hydroxides, and magnesium hydroxide, and brominated flame retardants (BRF). Halogenated flame retardants, particularly brominated retardants, are highly effective in achieving the requirements for fire classification, but their use is not preferred for environmental and safety issues. Halogen-free flame retardants are also widely used but their disadvantage is their inferior efficiency compared to other types of flame retardants.

Fire retarding properties of a polymeric substrates can also be improved by using fireproof materials, which are applied directly to a surface of the substrate. For example, it is known to use fire resistant fabrics to improve fireproofing properties of polymeric waterproofing membranes. Such fabrics are loosely laid on a surface of a membrane and fastened to the membrane by hot-air welding around the edges of the membrane. The disadvantage of using such fireproof fabrics is that the installation process is quite slow and requires use of specialized equipment. Furthermore, since the fabric is only partially affixed to the surface of the substrate, its resistance to environmental factors, such as wind loads and bird attacks, is quite low.

There is thus a need for an improved solution for improving the fire resistance properties of substrates in the field of construction industry, particularly of roof substrates.

### SUMMARY OF THE INVENTION

The object of the present invention is to provide a self-adhering sealing element, which can be used for improving fire resistance properties of substrates, particularly in the field of construction industry.

It was surprisingly found out that these objectives can be achieved with the adhesive tape of claim 1.

Specifically, according to the invention, an adhesive tape is provided, the tape comprising:
i) A metal film (2) having first and second major surfaces and a thickness of not more than 100 μm,
ii) A polymeric support layer (3) having first and second major surfaces,
iii) A pressure sensitive adhesive layer (4), and
iv) Optionally a release liner (5) covering an outer major surface of the pressure sensitive adhesive layer (4) facing away from the polymeric support layer (3),
wherein the polymeric support layer (3) is arranged between the metal film (2) and the pressure sensitive adhesive layer (4).

As it turned out, the suggested tape provides an effective solution to improve the ability of substrates to delay or stop the spread of flames. The tape is very easy to apply to a surface of the substrate and the installation does not require the use of specialized equipment such as heat welding tools. Furthermore, an installed tape has good resistance to environmental factors since it is fully bonded to the surface.

Further aspects of the invention are described below and are subject of the further independent claims. Particularly preferred embodiments are outlined throughout the description and in the dependent claims.

### BRIEF DESCRIPTION OF THE DRAWINGS

FIG. 1 shows a cross-section of an adhesive tape (1) comprising a metal film (2), a polymeric support layer (3) having first and second major surfaces, a pressure sensitive adhesive layer (4), and a release liner (5) covering an outer major surface of the pressure sensitive adhesive layer (4) facing away from the polymeric support layer (3).

FIG. 2 shows a cross-section of a fireproofed structure comprising a substrate (6) and an adhesive tape (1) as shown in FIG. 1 without the release liner (5), wherein the polymeric support layer (3) of the adhesive tape (1) is bonded to a surface of the substrate (6) via the pressure sensitive adhesive layer (4).

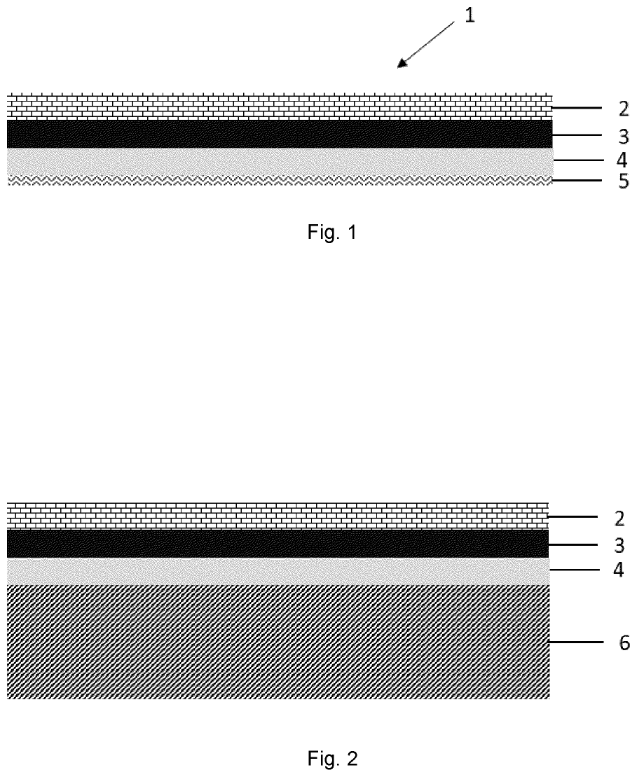

### DETAILED DESCRIPTION OF THE INVENTION

The subject of the present invention is an adhesive tape is provided, the tape comprising:
i) A metal film (2) having first and second major surfaces and a thickness of not more than 100 μm,
ii) A polymeric support layer (3) having first and second major surfaces,
iii) A pressure sensitive adhesive layer (4), and
iv) Optionally a release liner (5) covering an outer major surface of the pressure sensitive adhesive layer (4) facing away from the polymeric support layer (3),
wherein the polymeric support layer (3) is arranged between the metal film (2) and the pressure sensitive adhesive layer (4).

The term “polymer” refers to a collective of chemically uniform macromolecules produced by a polyreaction (polymerization, polyaddition, polycondensation) where the macromolecules differ with respect to their degree of polymerization, molecular weight and chain length. The term also comprises derivatives of said collective of macromolecules resulting from polyreactions, that is, compounds which are obtained by reactions such as, for example, additions or substitutions, of functional groups in predetermined macromolecules and which may be chemically uniform or chemically non-uniform.

The term “elastomer” designates a polymer or a polymer blend, which is capable of recovering from large deformations, and which can be, or already is, modified to a state in which it is essentially insoluble (but can swell) in a boiling solvent, in particular xylene. Typical elastomers are capable of being elongated or deformed to at least 200% of their original dimension under an externally applied force, and will substantially resume the original dimensions, sustaining only small permanent set (typically no more than about 20%), after the external force is released. As used herein, the term “elastomer” may be used interchangeably with the term “rubber.”

The term “copolymer” refers to a polymer derived from more than one species of monomer (“structural unit”). The polymerization of monomers into copolymers is called copolymerization. Copolymers obtained by copolymerization of two monomer species are known as bipolymers and those obtained from three and four monomer species are called terpolymers and quaterpolymers, respectively.

The term “melting temperature” designates a temperature at which a material undergoes transition from the solid to the liquid state. The melting temperature (Tₘ) is preferably determined by differential scanning calorimetry (DSC) according to ISO 11357-3 standard using a heating rate of 2° C./min. The measurements can be performed with a Mettler Toledo DSC 3+ device and the Tₘ values can be determined from the measured DSC-curve with the help of the DSC-software. In case the measured DSC-curve shows several peak temperatures, the first peak temperature coming from the lower temperature side in the thermogram is taken as the melting temperature (Tₘ).

The term “glass transition temperature” (T_{g}) designates the temperature above which temperature a polymer component becomes soft and pliable, and below which it becomes hard and glassy. The glass transition temperature is preferably determined by dynamical mechanical analysis (DMA) as the peak of the measured loss modulus (G″) curve using an applied frequency of 1 Hz and a strain level of 0.1%.

The term “molecular weight” designates the molar mass (g/mol) of a molecule or a part of a molecule, also referred to as “moiety”. The term “average molecular weight” refers to weight average (M_{w}) or number average (Mₙ) molecular weight of an oligomeric or polymeric mixture of molecules or moieties. The molecular weight may be determined by conventional methods, preferably by gel permeation-chromatography (GPC) using polystyrene as standard, styrene-divinylbenzene gel with porosity of 100 Angstrom, 1000 Angstrom and 10000 Angstrom as the column and, depending on the molecule, tetrahydrofurane as a solvent, at 35° C., or 1,2,4-trichlorobenzene as a solvent, at 160° C.

The term “crosslinked” refers to a polymer matrix, in which the polymer chains are inter-connected by a plurality of covalent bonds that are stable mechanically and thermally.

Other possible forms of crosslinked polymers such as physically crosslinked polymers are not regarded as “crosslinked” in the context of the present disclosure. The term “vulcanized” may be used interchangeably with the term “crosslinked”.

The “amount or content of at least one component X” in a composition, for example “the amount of the at least one thermoplastic polymer refers to the sum of the individual amounts of all thermoplastic polymers contained in the composition. Furthermore, in case the composition comprises 20 wt.-% of the at least one thermoplastic polymer, the sum of the amounts of all thermoplastic polymers contained in the composition equals 20 wt.-%.

The term “room temperature” designates a temperature of 23° C.

The adhesive tape of the present invention contains as a first layer a metal film.

The terms “film” and “layer” refers in the present disclosure to a sheet-like element having first and second major surfaces, i.e., top and bottom surfaces, a width defined between the longitudinally extending edges, and a thickness defined between the first and second major surfaces. Preferably, a sheet-like element has a length and width at least 5 times, more preferably at least 15 times, even more preferably at least 25 times greater than the thickness of the element.

Especially, the metal film (2) has a thickness of 10-100 μm, preferably 25-75 μm, more preferably 35-65 μm, even more preferably 40-60 μm. Such metal films have been found out to provide the adhesive tape with excellent fire resistance properties without increasing the material costs to an unacceptable level.

In a preferred embodiment, the metal film (2) is an aluminum film.

The second layer of the adhesive tape is composed of a polymeric support layer (3). The term “polymeric” refers here to materials composed of one or more polymers or having one or more polymers as the main component, i.e., making up at least 50 wt.-% of the total weight of the material.

Particularly, the polymeric support layer (3) has a thickness of not more than 100 μm, preferably not more than 85 μm, especially 5-75 μm, preferably 5-60 μm, more preferably 10-45 μm, even more preferably 10-35 μm.

Especially, the polymeric support layer (3) has a width of 10-1000 mm, more preferably 25-750 mm, even more preferably 35-650 mm, still more preferably 50-500 mm.

The terms “width” and “length” refer to the two perpendicular dimensions measured in the horizontal plane of the first and second major surfaces of a sheet-like element. Generally, the “width” of a sheet like element is the smaller of the horizontal dimensions of the sheet-like element. Consequently, the “width” of the polymeric support layer refers to the minor dimension measured in the horizontal plane of the polymeric support layer in a direction perpendicular to the length of the polymeric support layer.

Suitable polymers for use in the support layer (3) include, for example, such as polyolefins, polyvinylchloride, ethylene vinyl acetate copolymers, polyamide, polyethylene terephthalate, polyvinylidene fluoride, polyvinyl fluoride, polyvinyl alcohol, and ethylene vinyl alcohol.

Especially, the polymeric support layer (3) comprises at least one polymer selected from polyethylene, polyethylene terephthalate, and polyamide, preferably from polyethylene and polyethylene terephthalate.

Suitable polyethylenes to be used in the polymeric support layer include ethylene homopolymers, such as low-density polyethylene, linear low-density polyethylene, and high-density polyethylene, preferably having a melting temperature (Tₘ), determined by differential scanning calorimetry (DSC) according to ISO 11357-3:2018 standard using a heating rate of 2° C./min, of at or above 100° C., preferably at or above 105° C., more preferably at or above 110° C.

The term “polyethylene terephthalate (PET)” refers in the present disclosure to a thermoplastic polyester resin that includes both PET polymers and copolymers. For example, PET can be provided as a copolymer having, in addition to terephthalic acid residues and ethylene glycol residues, additional isophthalic acid residues and/or cyclohexanedimethanol residues. PET can exist both as an amorphous (transparent) and as a semi-crystalline (opaque and white) material. PET can also exist as a semi crystalline transparent material.

Especially suitable polyethylene terephthalates for use in the polymeric support layer have a high content of ethylene terephthalate units, such as at least 90 wt.-%, preferably at least 95 wt.-%, more preferably at least 97.5 wt.-%, based on the weight of the polyethylene terephthalate and/or a low content of dioxyethylene terephthalate units, such as not more than 10 wt.-%, preferably not more than 5 wt.-%, more preferably not more than 2.5 wt.-%, based on the weight of the polyethylene terephthalate.

Suitable polyethylene terephthalates are commercially available, for example, under the trade name of Vituf® (from Goodyear Chemical Company); under the trade name of Impet® (from Celanese), and under the trade name of Mylar® (from Dupont).

Particularly, the at least one polymer is present in the polymeric support layer (3) in an amount of at least 50 wt.-%, preferably at least 65 wt.-%, more preferably at least 75 wt.-%, even more preferably at least 85 wt.-%, based on the total weight of the polymeric support layer (3).

The polymeric support layer (3) may comprise, in addition to the polymer(s), further constituents, such as fillers, UV- and heat stabilizers, antioxidants, plasticizers, flame retardants, dyes, pigments, matting agents, antistatic agents, impact modifiers, biocides, and processing aids such as lubricants, slip agents, antiblock agents, and denest aids.

In a preferred embodiment, the polymeric support layer (3) comprises polyethylene terephthalate as the at least one polymer, preferably having a melting temperature (Tₘ), determined by differential scanning calorimetry (DSC) according to ISO 11357-3:2018 standard using a heating rate of 2° C./min, of at or above 200° C., preferably at or above 225° C., more preferably at or above 250° C.

Particularly, the metal film (2) and the polymeric support layer (3) are indirectly connected to each other over at least a portion of their opposing major surfaces, wherein the metal film (2) preferably covers at least 50%, more preferably at least 75%, of the area of the first major surface of the polymeric support layer (3).

The expression “directly connected” is understood to mean in the context of the present invention that no further layer or substance is present between the two layers and that the opposing surfaces of the layers are directly bonded to each other or adhere to each other.

The expression “indirectly connected” is understood to mean that the layers are connected to each other via a connecting layer, such an adhesive layer.

In one preferred embodiment, the metal film (2) and the polymeric support layer (3) have been adhesively laminated to each other, i.e., the layers are indirectly connected to each other over at least a portion of their opposing major surfaces via an adhesive layer.

Especially, the first major surface of the metal film may form one of the primary exterior surfaces of the adhesive tape. The term “primary exterior surface” refers in the present disclosure an outermost surface of a sheet-like element, which outermost surface is not covered by any other layer.

The third layer of the adhesive tape is a pressure sensitive adhesive layer.

The term “pressure sensitive adhesive (PSA)” refers in the present disclosure to viscoelastic materials, which adhere immediately to almost any kind of substrates by application of light pressure, and which are permanently tacky. The tackiness of an adhesive layer can be measured, for example, as a loop tack.

The term “pressure sensitive adhesive layer” refers to an adhesive layer that has been obtained by using a pressure sensitive adhesive, i.e., by using a process comprising applying a pressure sensitive adhesive composition to a surface of a substrate to form an adhesive layer.

Furthermore, the term “pressure sensitive adhesive” refers to all types of pressure sensitive adhesives independently of the technique that is used for applying the adhesive composition to a surface a substrate to form an adhesive layer. Consequently, pressure sensitive adhesives that are applied as a dispersion, such as water- and solvent based adhesives, as a hot-melt, or as a “syrup”, and subsequently cured, for example by drying or cooling (“physical curing”), or by initiation of chemical reactions (“chemical curing”), for example by subjecting the adhesive layer to actinic radiation, are considered to be encompassed by the term “pressure sensitive adhesive”.

Particularly, the pressure sensitive adhesive layer has a loop tack adhesion to a glass plate measured at a temperature of 23° C. of at least 2.5 N/25 mm, preferably at least 5 N/25 mm, more preferably at least 10 N/25 mm.

The loop tack adhesion can be measured using a “FINAT test method no. 9 (FTM 9) as defined in FINAT Technical Handbook, 9th edition, published in 2014.

Especially, the polymeric support layer (3) and pressure sensitive adhesive layer (4) are directly connected to each other over at least a portion of their opposing major surfaces, wherein the pressure sensitive adhesive layer (4) preferably covers at least 50%, more preferably at least 75%, of the area of the second major surface of the polymeric support layer (3).

In one embodiment, the pressure sensitive adhesive layer (4) has a thickness of not more than 1.5 mm, preferably 0.1-1.5 mm, more preferably 0.25-1.0 mm.

The pressure sensitive adhesive layer can be a in form of a continuous or discontinuous adhesive layer.

The term “continuous adhesive layer” is understood to mean that the adhesive layer is composed of one single area on a surface coated with the adhesive. In contrast, the term “discontinuous adhesive layer” is understood to mean that the adhesive layer has a pattern composed of adhesive coated areas and adhesive free areas (voids). In case of a discontinuous adhesive layer, the term “thickness of the adhesive layer” is understood to mean the arithmetic average of the thicknesses of the adhesive coated areas.

In one preferred embodiment, the pressure sensitive adhesive layer (4) is in form of a continuous adhesive layer.

Especially suitable pressure sensitive adhesives for the pressure sensitive adhesive layer (4) include synthetic rubber-, natural rubber-, and bitumen-based pressure sensitive adhesives, and acrylic pressure sensitive adhesives.

Such adhesives typically contain one or more compounds selected from the group consisting of styrene block copolymers, amorphous polyolefins (APO), amorphous poly-alpha-olefins (APAO), vinyl ether polymers, acrylic polymers, polyurethanes, and rubbers such as, for example, styrene-butadiene rubber (SBR), ethylene propylene diene monomer (EPDM) rubber, butyl rubber, polyisoprene, polybutadiene, natural rubber, polychloroprene rubber, ethylene-propylene rubber (EPR), nitrile rubber, acrylic rubber, ethylene vinyl acetate (EVA) rubber, and silicone rubber.

In addition to the above-mentioned compounds, pressure sensitive adhesives typically comprise one or more additional constituents including, for example, monomers, tackifying resins, plasticizers, waxes, and additives, such as UV- and heat stabilizers, UV-absorbers, optical brighteners, pigments, dyes, and desiccants.

According to one embodiment, the pressure sensitive adhesive is a styrene copolymer-based adhesive comprising:
A) 15-75 wt.-%, preferably 25-65 wt.-%, more preferably 35-60 wt.-%, of at least one styrene block copolymer SC,
B) 2.5-85 wt.-%, preferably 5-75 wt.-%, more preferably 10-65 wt.-%, of at least one tackifying resin TR,
C) 0-35 wt.-%, preferably 2.5-25 wt.-%, more preferably 5-15 wt.-%, of at least one mineral filler MF,
D) 0-30 wt.-%, preferably 2.5-25 wt.-%, more preferably 5-15 wt.-%, of at least one plasticizer PL, all proportions being based on the total weight of the styrene copolymer-based adhesive.

Suitable styrene block copolymers for use as the at least one styrene block copolymer SC include styrene block copolymers of the SXS type, in each of which S denotes a non-elastomer styrene (or polystyrene) block and X denotes an elastomeric α-olefin block, which may be polybutadiene, polyisoprene, polyisoprene-polybutadiene, completely or partially hydrogenated polyisoprene (poly ethylene-propylene), or completely or partially hydrogenated polybutadiene (poly ethylene-butylene). The elastomeric α-olefin block preferably has a glass transition temperature in the range from −55° C. to −35° C. The elastomeric α-olefin block may also be a chemically modified α-olefin block. Particularly suitable chemically modified α-olefin blocks include, for example, maleic acid-grafted α-olefin blocks and particularly maleic acid-grafted ethylene-butylene blocks.

According to one or more embodiments, the at least one styrene block copolymer SC is selected from the group consisting of styrene-butadiene-styrene (SBS), styrene-isoprene-styrene (SIS), styrene-isoprene-butadiene-styrene (SIBS), styrene-ethylene-butadiene-styrene (SEBS), and styrene-ethylene-propene-styrene (SEPS) block copolymers.

The term “tackifying resin” designates in the present disclosure resins that in general enhance the adhesion and/or tackiness of an adhesive composition. The term “tackiness” designates in the present disclosure the property of a substance of being sticky or adhesive by simple contact. The tackiness can be measured, for example, as a loop tack. Preferred tackifying resins are tackifying at a temperature of 25° C. or below.

Examples of suitable compounds to be used as the at least one tackifying resin TR include natural resins, synthetic resins and chemically modified natural resins.

Examples of suitable natural resins and chemically modified natural resins include rosins, rosin esters, phenolic modified rosin esters, and terpene resins. The term “rosin” is to be understood to include gum rosin, wood rosin, tall oil rosin, distilled rosin, and modified rosins, for example dimerized, hydrogenated, maleated and/or polymerized versions of any of these rosins.

Suitable terpene resins include copolymers and terpolymers of natural terpenes, such as styrene/terpene and alpha methyl styrene/terpene resins; polyterpene resins generally resulting from the polymerization of terpene hydrocarbons, such as the bicyclic monoterpene known as pinene, in the presence of Friedel-Crafts catalysts at moderately low temperatures; hydrogenated polyterpene resins; and phenolic modified terpene resins including hydrogenated derivatives thereof.

The term “synthetic resin” refers to compounds obtained from the controlled chemical reactions such as polyaddition or polycondensation between well-defined reactants that do not themselves have the characteristic of resins.

Monomers that may be polymerized to synthesize the synthetic resins may include aliphatic monomer, cycloaliphatic monomer, aromatic monomer, or mixtures thereof. Aliphatic monomers can include C₄, C₅, and C₆ paraffins, olefins, and conjugated diolefins. Examples of aliphatic monomer or cycloaliphatic monomer include butadiene, isobutylene, 1,3-pentadiene, 1,4-pentadiene, cyclopentane, 1-pentene, 2-pentene, 2-methyl-1-pentene, 2-methyl-2-butene, 2-methyl-2-pentene, isoprene, cyclohexane, 1,3-hexadiene, 1,4-hexadiene, cyclopentadiene, dicyclopentadiene, and terpenes. Aromatic monomer can include C₈, C₉, and C₁₀ aromatic monomer. Examples of aromatic monomer include styrene, indene, derivatives of styrene, derivatives of indene, coumarone, and combinations thereof.

Particularly suitable synthetic resins include synthetic hydrocarbon resins made by polymerizing mixtures of unsaturated monomers that are obtained as by-products of cracking of natural gas liquids, gas oil, or petroleum naphthas. Synthetic hydrocarbon resins obtained from petroleum-based feedstocks are referred in the present disclosure as “hydrocarbon resins” or “petroleum hydrocarbon resins”. These include also pure monomer aromatic resins, which are made by polymerizing aromatic monomer feedstocks that have been purified to eliminate color causing contaminants and to precisely control the composition of the product. Hydrocarbon resins typically have a relatively low average molecular weight (Mₙ), such in the range of 250-5000 g/mol and a glass transition temperature, determined by dynamical mechanical analysis (DMA) as the peak of the measured loss modulus (G″) curve using an applied frequency of 1 Hz and a strain level of 0.1%, of above 0° C., preferably equal to or higher than 15° C., more preferably equal to or higher than 30° C.

Examples of suitable hydrocarbon resins include C5 aliphatic hydrocarbon resins, mixed C5/C9 aliphatic/aromatic hydrocarbon resins, aromatic modified C5 aliphatic hydrocarbon resins, cycloaliphatic hydrocarbon resins, mixed C5 aliphatic/cycloaliphatic hydrocarbon resins, mixed C9 aromatic/cycloaliphatic hydrocarbon resins, mixed C5 aliphatic/cycloaliphatic/C9 aromatic hydrocarbon resins, aromatic modified cycloaliphatic hydrocarbon resins, C9 aromatic hydrocarbon resins, polyterpene resins, and copolymers and terpolymers of natural terpenes as well hydrogenated versions of the aforementioned hydrocarbon resins. The notations “C5” and “C9” indicate that the monomers from which the resins are made are predominantly hydrocarbons having 4-6 and 8-10 carbon atoms, respectively. The term “hydrogenated” includes fully, substantially and at least partially hydrogenated resins. Partially hydrogenated resins may have a hydrogenation level, for example, of 50%, 70%, or 90%.

Suitable hydrocarbon resins are commercially available, for example, under the trade name of Wingtack® series, Wingtack® Plus, Wingtack® Extra, and Wingtack® STS (all from Cray Valley); under the trade name of Escorez® 1000 series, Escorez® 2000 series, and Escorez® 5000 series (all from Exxon Mobile Chemical); under the trade name of Novares® T series, Novares® TT series, Novares® TD series, Novares® TL series, Novares® TN series, Novares® TK series, and Novares® TV series (all from Rain Carbon); and under the trade name of Kristalex®, Plastolyn®, Piccotex®, Piccolastic® and Endex® (all from Eastman Chemicals).

According to one or more embodiments, the at least one tackifying resin TR has:
a softening point measured by a Ring and Ball method according to DIN EN 1238 standard in the range of 65-200° C., preferably 75-175° C., more preferably 80-170° C. and/or
an average molecular weight (Mₙ) in the range of 150-5000 g/mol, preferably 250-3500 g/mol, more preferably 250-2500 g/mol and/or
a glass transition temperature (T_{g}) determined by dynamical mechanical analysis (DMA) as the peak of the measured loss modulus (G″) curve using an applied frequency of 1 Hz and a strain level of 0.1% of at or above 0° C., preferably at or above 15° C., more preferably at or above 25° C., even more preferably at or above 30° C., still more preferably at or above 35° C.

Suitable compounds to be used as the at least one plasticizer PL are liquid plasticizers. The term “liquid” is generally defined as a material that flows at normal room temperature, has a pour point of less than 20° C. and/or a kinematic viscosity at 25° C. of 50000 cSt or less.

According to one or more embodiments, the at least one plasticizer PL is selected from the group consisting of mineral oils, synthetic oils, vegetable oils, and at 25° C. liquid hydrocarbon resins.

Suitable at 25° C. liquid hydrocarbon resins for use as the plasticizer PL include at 25° C. liquid polybutenes and at 25° C. liquid polyisobutylenes (PIB). The term “at 25° C. liquid polybutene” designates in the present disclosure low molecular weight olefin oligomers comprising isobutylene and/or 1-butene and/or 2-butene. The ratio of the C₄-olefin isomers can vary by manufacturer and by grade. When the C4-olefin is exclusively 1-butene, the material is referred to as “poly-n-butene” or “PNB”. The term “at 25° C. liquid polyisobutylene” designates in the present disclosure low molecular weight polyolefins and olefin oligomers of isobutylene, preferably containing at least 75%, more preferably at least 85% of repeat units derived from isobutylene. Particularly suitable at 25° C. liquid polybutenes and polyisobutylenes have a molecular weight (Mₙ) of not more than 10000 g/mol, preferably not more than 5000 g/mol, more preferably not more than 3500 g/mol, even more preferably not more than 3000 g/mol, still more preferably not more than 2500 g/mol.

Liquid polybutenes are commercially available, for example, under the trade name of Indopol® H- and L-series (from Ineos Oligomers), under the trade name of Infineum® C-series and Parapol® series (from Infineum), and under the trade name of PB-series (Daelim). Liquid polyisobutylenes (PIBs) are commercially available, for example, under the trade name of Glissopal® V-series (from BASF) and and under the trade name of Dynapak®-series (from Univar GmbH, Germany).

According to one or more embodiments, the at least one mineral filler MF is selected from the group consisting of sand, granite, calcium carbonate, clay, expanded clay, diatomaceous earth, pumice, mica, kaolin, talc, dolomite, xonotlite, perlite, vermiculite, wollastonite, barite, magnesium carbonate, calcium hydroxide, calcium aluminates, silica, fumed silica, fused silica, aerogels, glass beads, hollow glass spheres, ceramic spheres, bauxite, comminuted concrete, and zeolites.

The term “sand” refers in the present disclosure to mineral clastic sediments (clastic rocks) which are loose conglomerates (loose sediments) of round or angular small grains, which were detached from the original grain structure during the mechanical and chemical degradation and transported to their deposition point, said sediments having an SiO₂ content of greater than 50 wt.-%, in particular greater than 75 wt.-%, particularly preferably greater than 85 wt.-%. The term “calcium carbonate” as mineral filler refers in the present document to calcitic fillers produced from chalk, limestone, or marble by grinding and/or precipitation.

According to one or more embodiments, the at least one mineral filler MF is selected from the group consisting of calcium carbonate, clay, expanded clay, diatomaceous earth, pumice, mica, kaolin, talc, dolomite, xonotlite, perlite, vermiculite, wollastonite, barite, magnesium carbonate, calcium hydroxide, calcium aluminates, silica, fumed silica, and fused silica.

Preferably, the at least one mineral filler MF has a median particle size d₅₀ of not more than 150 μm, more preferably not more than 100 μm. According to one or more embodiments, the at least one solid filler F has a median particle size d₅₀ of 0.1-100 μm, preferably 0.15-50 μm, more preferably 0.15-25 μm, even more preferably 0.25-15 μm.

The term “particle size” refers in the present disclosure to the area-equivalent spherical diameter of a particle (Xₐᵣₑₐ). The term “median particle size d₅₀” refers to a particle size below which 50% of all particles by volume are smaller than the d₅₀ value. In analogy, the term d₉₀ particle size refers in the present disclosure to a particle size below which 90% of all particles by volume are smaller than the d₉₀ value and term “d₁₀ particle size” refers to a particle size below which 10% of all particles by volume are smaller than the d₁₀ value. A particle size distribution can be measured by laser diffraction according to the method as described in standard ISO 13320:2009 using a wet or dry dispersion method and for example, a Mastersizer 2000 device (trademark of Malvern Instruments Ltd, GB).

According to a further embodiment, the pressure sensitive adhesive is a natural rubber-based adhesive comprising:
A) 15-75 wt.-%, preferably 25-65 wt.-%, more preferably 35-60 wt.-%, of at least one natural rubber NR,
B) 2.5-85 wt.-%, preferably 5-75 wt.-%, more preferably 10-65 wt.-%, of the at least one tackifying resin TR,
C) 0-35 wt.-%, preferably 2.5-25 wt.-%, more preferably 5-15 wt.-%, of the at least one mineral filler MF, all proportions being based on the total weight of the natural rubber-based adhesive.

According to a further embodiment, the pressure sensitive adhesive is a bitumen-based adhesive comprising:
A) 15-90 wt.-%, preferably 25-85 wt.-%, more preferably 35-75 wt.-%, even more preferably 40-70 wt.-%, of bitumen B and
A′) 5-35 wt.-%, preferably 10-30 wt.-%, more preferably 15-30 wt.-%, even more preferably 20-30 wt.-%, of at least one modifying polymer MP,
B) 2.5-30 wt.-%, preferably 5-25 wt.-%, of the at least one tackifying resin TR and/or
C) 2.5-30 wt.-%, preferably 5-25 wt.-%, of the at least one mineral filler MF, and/or
D) 0.5-15 wt.-%, preferably 2.5-10 wt.-%, of the at least one plasticizer PL, all proportions being based on the total weight of the bitumen-based adhesive.

The term “bitumen” designates in the present disclosure blends of heavy hydrocarbons, having a solid consistency at room temperature, which are normally obtained as vacuum residue from refinery processes, which can be distillation (topping or vacuum) and conversion (thermal cracking and visbreaking) processes of suitable crude oils. Furthermore, the term “bitumen” also designates natural and synthetic bitumen as well as bituminous materials obtained from the extraction of tars and bituminous sands.

The bitumen B can comprise one of more different types of bitumen materials, such as penetration grade (distillation) bitumen, air-rectified (semi-blown) bitumen, and hard grade bitumen.

The term “penetration grade bitumen” refers here to bitumen obtained from fractional distillation of crude oil. A heavy fraction composed of high molecular weight hydrocarbons, also known as long residue, which is obtained after removal of gasoline, kerosene, and gas oil fractions, is first distilled in a vacuum distillation column to produce more gas oil, distillates, and a short residue. The short residue is then used as a feed stock for producing different grades of bitumen classified by their penetration index, typically defined by a PEN value, which is the distance in tenth millimeters (dmm) that a needle penetrates the bitumen under a standard test method. Penetration grade bitumen are characterized by penetration and softening point. The term “air-rectified bitumen” or “air-refined bitumen” refers in the present disclosure to a bitumen that has been subjected to mild oxidation with the goal of producing a bitumen that meets paving-grade bitumen specifications. The term “hard grade bitumen” refers in the present disclosure to bitumen produced using extended vacuum distillation with some air rectification from propane-precipitated bitumen. Hard bitumen typically has low penetration values and high softening-points.

According to one or more embodiments, the bitumen B comprises at least 75 wt.-%, preferably at least 85 wt.-%, more preferably at least 90 wt.-% of at least one penetration grade bitumen, preferably having a penetration value in the range of 30-300 dmm, more preferably 70-220 dmm, even more preferably 100-160 and/or a softening point determined by Ring and Ball measurement conducted according to DIN EN 1238 standard in the range of 30-100° C., more preferably 30-70° C., even more preferably 30-50° C.

Suitable compounds for use as the modifying polymer MP include, for example, polyolefins, such as atactic polypropylene (APP), amorphous polyolefins (APO), styrene block copolymers, and rubbers.

The term “amorphous polyolefin (APO)” refers in the present disclosure to polyolefins having a low crystallinity degree determined by a differential scanning calorimetry (DSC) measurement, such as in the range of 0.001-10 wt.-%, preferably 0.001-5 wt.-%. The crystallinity degree of a polymer can be determined by using the differential scanning calorimetry measurements conducted according to ISO 11357 standard to determine the heat of fusion, from which the degree of crystallinity is calculated. In particular, the term “amorphous polyolefin” designates poly-α-olefins lacking a crystalline melting point (Tₘ) as determined by differential scanning calorimetric (DSC) or equivalent technique.

Suitable amorphous polyolefins for use as the modifying polymer MP include, for example, amorphous propene rich copolymers of propylene and ethylene, amorphous propene rich copolymers of propylene and butene, amorphous propene rich copolymers of propylene and hexene, and amorphous propene rich terpolymers of propylene, ethylene, and butene. The term “propene rich” is understood to mean copolymers and terpolymers having a content of propene derived units of at least 50 wt.-%, preferably at least 65 wt.-%, more preferably at least 70 wt.-%, based on total weight of the copolymer/terpolymer.

Preferred styrene block copolymers for use as the modifying polymer MP include, for example, styrene-butadiene-styrene (SBS), styrene-isoprene-styrene (SIS), styrene-isoprene-butadiene-styrene (SIBS), styrene-ethylene-butadiene-styrene (SEBS), and styrene-ethylene-propene-styrene (SEPS) block copolymers, preferably having a linear, radial, diblock, triblock or a star structure.

Suitable rubbers for use as the modifying polymer MP include, for example, styrene-butadiene rubber (SBR), ethylene propylene diene monomer rubber (EPDM), polyisoprene, polybutadiene, natural rubber, polychloroprene rubber, ethylene-propylene rubber (EPR), nitrile rubbers, and acrylic rubbers.

According to one or more embodiments, the at least one modifying polymer MP is selected from the group consisting of atactic polypropylene (APP), amorphous polyolefins (APO), styrene-butadiene-styrene (SBS) block copolymer, styrene-isoprene-styrene (SIS) block copolymer, styrene-butadiene rubber (SBR), ethylene propylene diene monomer (EPDM) rubber, polyisoprene, polybutadiene, natural rubber, polychloroprene rubber, ethylene-propylene rubber (EPR), nitrile rubbers, and acrylic rubbers, preferably from the group consisting of atactic polypropylene (APP), amorphous polyolefins (APO), styrene-butadiene-styrene (SBS) block copolymer, styrene-isoprene-styrene (SIS) block copolymer, and styrene-butadiene rubber (SBR).

According to a preferred embodiment, the pressure sensitive adhesive is a butyl rubber-based pressure sensitive adhesive, preferably comprising 15-75 wt.-%, preferably 25-65 wt.-%, based on the total weight of the butyl rubber-based pressure sensitive adhesive, of butyl rubber BR.

The term “butyl rubber” designates in the present disclosure a polymer derived from a monomer mixture containing a major portion of a C₄ to C₇ monoolefin monomer, preferably an isoolefin monomer and a minor portion, such as not more than 30 wt.-%, of a C₄ to C₁₄ multiolefin monomer, preferably a conjugated diolefin.

The preferred C₄ to C₇ monoolefin monomer may be selected from the group consisting of isobutylene, 2-methyl-1-butene, 3-methyl-1-butene, 2-methyl-2-butene, 4-methyl-1-pentene, and mixtures thereof.

The preferred C₄ to C₁₄ multiolefin comprises a C₄ to C₁₀ conjugated diolefin. The preferred C₄ to C₁₀ conjugated diolefin may be selected from the group comprising isoprene, butadiene, 2,4-dimethylbutadiene, piperyline, 3-methyl-1,3-pentadiene, 2,4-hexadiene, 2-neopentyl-1,3-butadiene, 2-methyl-1,5-hexadiene, 2,5-dimethyl-2,4-hexadiene, 2-methyl-1,4-pentadiene, 2-methyl-1,6-heptadiene, cyclopentadiene, methylcyclopentadiene, cyclohexadiene, 1-vinyl-cyclohexadiene and mixtures thereof.

Preferably, the butyl rubber BR is derived from a monomer mixture containing from about 80 wt.-% to about 99 wt.-% of a C₄ to C₇ monoolefin monomer and from about 1.0 wt.-% to about 20 wt.-% of a C₄ to C₁₄ multiolefin monomer. More preferably, the monomer mixture contains from about 85 wt.-% to about 99 wt.-% of a C₄ to C₇ monoolefin monomer and from about 1.0 wt.-% to about 10 wt.-% of a C₄ to C₁₄ multiolefin monomer. Most preferably, the monomer mixture contains from about 95 wt.-% to about 99 wt.-% of a C₄ to C₇ monoolefin monomer and from about 1.0 wt.-% to about 5.0 wt.-% of a C₄ to C₁₄ multiolefin monomer.

In a preferred embodiment, the butyl rubber is derived from a monomer mixture comprising from about 97 wt.-% to about 99.5 wt.-% of isobutylene and from about 0.5 wt.-% to about 3 wt.-% of isoprene.

It is furthermore possible to include an optional third monomer to produce a butyl terpolymer.

For example, it is possible to include a styrenic monomer in the monomer mixture, preferably in an amount up to about 15 wt.-% of the monomer mixture. The preferred styrenic monomer may be selected from the group comprising p-methylstyrene, styrene, α-methylstyrene, p-chlorostyrene, p-methoxystyrene, indene, indene derivatives and mixtures thereof. The most preferred styrenic monomer may be selected from the group comprising styrene, p-methylstyrene and mixtures thereof. Other suitable copolymerizable termonomers will be apparent to those of skilled in the art.

Particularly, the butyl rubber-based pressure sensitive adhesive comprises:
A) 15-75 wt.-%, preferably 25-65 wt.-%, more preferably 35-60 wt.-%, of the butyl rubber BR,
B) 1-65 wt.-%, preferably 2.5-55 wt.-%, more preferably 5-45 wt.-%, of the at least one tackifying resin TR,
C) 0-35 wt.-%, preferably 1-30 wt.-%, more preferably 2.5-25 wt.-%, of the at least one mineral filler MF, and
D) 0-30 wt.-%, preferably 1.5-25 wt.-%, more preferably 2.5-20 wt.-%, of the at least one plasticizer PL, all proportions being based on the total weight of the butyl rubber-based adhesive.

According to a further embodiment, the pressure sensitive adhesive is an acrylic pressure sensitive adhesive. The term “acrylic pressure sensitive adhesive” designates in the present disclosure pressure sensitive adhesives containing one or more acrylic polymers as the main polymer component.

The term “acrylic polymer” designates in the present disclosure homopolymers, copolymers and higher inter-polymers of an acrylic monomer with one or more further acrylic monomers and/or with one or more other ethylenically unsaturated monomers. The term “monomer” refers to a compound that chemically bonds to other molecules, including other monomers, to form a polymer. The term “acrylic monomer” refers to monomers having at least one (meth)acryloyl group in the molecule. The term “(meth)acryloyl” designates methacryloyl or acryloyl. Accordingly, the term “(meth)acrylic” designates methacrylic or acrylic. A (meth)acryloyl group is also known as (meth)acryl group.

The acrylic polymer(s) may further be present in the pressure sensitive adhesive as a physically or chemically crosslinked polymer or as part of a chemically crosslinked polymer network comprising other polymers than acrylic polymers or as part of an interpenetrating or semi-interpenetrating polymer network (IPN).

The term “interpenetrating polymer network” refers to a polymer network comprising two or more dissimilar polymers that are in network form, i.e., chemically, or physically crosslinked. In an IPN, the polymer chains are not chemically bonded, but they are physically entangled by permanent chain entanglements. In a semi-interpenetrating polymer network, the polymer network and a linear or branched polymer penetrate each other at the molecular level.

According to one or more embodiments, the acrylic pressure sensitive adhesive comprises at least 35 wt.-%, preferably at least 50 wt.-%, more preferably at least 65 wt.-%, even more preferably at least 75 wt.-%, of at least one acrylic polymer AP, based on the total weight of the acrylic pressure sensitive adhesive.

Examples of suitable acrylic monomers for use in the at least one acrylic polymer AP include, for example, (meth)acrylates, (meth)acrylic acid or derivatives thereof, for example, amides of (meth)acrylic acid or nitriles of (meth)acrylic acid, and (meth)acrylates with functional groups such as hydroxyl group-containing (meth)acrylates and alkyl (meth)acrylates.

According to one or more embodiments, the acrylic polymer AP has been obtained from a monomer mixture comprising at least 45 wt.-%, preferably at least 55 wt.-%, more preferably at least 65 wt.-%, even more preferably at least 75 wt.-%, still more preferably at least 85 wt.-%, based on the total weight of the monomer mixture, of at least one acrylic monomer AM of formula (I):

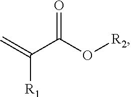

where
R₁ represents a hydrogen or a methyl group; and
R₂ represents a branched, unbranched, cyclic, acyclic, or saturated alkyl group having from 2 to 30 carbon atoms.

Examples of suitable acrylic monomers of formula (I) include methyl acrylate, methyl methacrylate, ethyl acrylate, ethoxy ethoxy ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, as for example isobutyl acrylate, 2-ethylhexyl acrylate, 2-ethylhexyl methacrylate, isooctyl acrylate, isooctyl methacrylate, and also cyclohexyl methacrylate, isobornyl acrylate, isobornyl methacrylate or 3,5-dimethyladamantyl acrylate.

Suitable comonomers to be used with the acrylic monomers of formula (I) include, for example, hydroxyl group containing acrylic monomers, such as 2-hydroxyethyl(meth)acrylate, 2-hydroxypropyl(meth)acrylate, 3-hydroxypropyl (meth)acrylate, 2-hydroxybutyl(meth)acrylate, 4-hydroxybutyl butyl(meth)acrylate, 2-hydroxy-hexyl(meth)acrylate, 6-hydroxy hexyl(meth) acrylate, 8-hydroxyoctyl(meth)acrylate, 10-hydroxydecyl (meth)acrylate, 12-hydroxylauryl(meth)acrylate. Further suitable hydroxyl group containing acrylic monomers include (4-hydroxymethyl cyclohexyl)methyl acrylate, polypropylene glycol mono (meth)acrylate, N-hydroxyethyl (meth)acrylamide, and N-hydroxypropyl (meth)acrylamide, esters of hydroxyethyl(meth)acrylate and phosphoric acid, and trimethoxysilylpropyl methacrylate.

According to one or more embodiments, the monomer mixture used for obtaining the at least one acrylic polymer AP comprises not more than 25 wt.-%, preferably not more than 20 wt.-%, such as 0.01-15 wt.-%, preferably 0.1-10 wt.-%, based on the total weight of the monomer mixture, of at least one hydroxyl group containing acrylic monomer.

Further suitable comonomers for the synthesis of the at least one acrylic polymer AP include vinyl compounds, such as ethylenically unsaturated hydrocarbons with functional groups, vinyl esters, vinyl halides, vinylidene halides, nitriles of ethylenically unsaturated hydrocarbons, phosphoric acid esters, and zinc salts of (meth)acrylic acid. Examples of especially suitable vinyl compounds include, for example, maleic anhydride, styrene, styrenic compounds, acrylic acid, beta-acryloyloxypropionic acid, vinylacetic acid, fumaric acid, crotonic acid, aconitic acid, trichloroacrylic acid, itaconic acid, vinyl acetate, and acryloyl morpholine.

According to one or more embodiments, the monomer mixture used for obtaining the at least one acrylic polymer AP comprises at least 0.1 wt.-%, preferably at least 0.5 wt.-%, such as 0.1-20 wt.-%, preferably 0.5-15 wt. %, based on the total weight of the monomer mixture, of at least one vinyl compound, preferably selected from the group consisting of maleic anhydride, styrene, styrenic compounds, (meth)acrylamides, N-substituted (meth)acrylamides, acrylic acid, beta-acryloyloxypropionic acid, vinylacetic acid, fumaric acid, crotonic acid, aconitic acid, dimethylacrylic acid, trichloroacrylic acid, itaconic acid, vinyl acetate, and amino group-containing (meth)acrylates.

According to one or more embodiments, the pressure sensitive adhesive layer (4) has been obtained by using a water- or solvent-based acrylic pressure sensitive adhesive composition, a hot-melt acrylic pressure sensitive adhesive composition or a syrup acrylic pressure sensitive adhesive composition.

The term “water-based pressure sensitive adhesive composition” designates in the present disclosure pressure sensitive adhesives, which have been formulated as an aqueous dispersion, an aqueous emulsion, or as an aqueous colloidal suspension. The term “aqueous dispersion” or “aqueous emulsion” refers to dispersions or emulsions containing water as the main continuous (carrier) phase. Typically, a water-based pressure sensitive adhesive composition comprises surfactants to stabilize the hydrophobic polymer particles and to prevent these from coagulating with each other.

The term “solvent-based pressure sensitive adhesive composition” designates in the present disclosure pressure sensitive adhesives comprising acrylic polymers, which are substantially completely dissolved in the organic solvent(s). Typically, the organic solvent(s) comprise at least 20 wt.-%, preferably at least 30 wt.-%, more preferably at least 40 wt.-%, of the total weight of the solvent-based pressure sensitive adhesive composition. The term “organic solvent” refers in the present document to organic substances that are liquid at a temperature of 25° C., are able to dissolve another substance at least partially, and have a standard boiling point of not more than 225° C., preferably not more than 200° C. The term “standard boiling point” refers in the present disclosure to boiling point measured at a pressure of 1 bar. The standard boiling point of a substance or composition can be determined, for example, by using an ebulliometer.

Suitable organic solvents for the solvent-based pressure sensitive adhesive composition include, for example, alcohols, aliphatic and aromatic hydrocarbons, ketones, esters, and mixtures thereof. It is possible to use only a single organic solvent or a mixture of two or more organic solvents. Suitable solvent-based pressure sensitive adhesive compositions are substantially water-free, for example, containing less than 10 wt.-%, preferably less than 5 wt.-%, more preferably less than 1 wt.-% of water, based on the total weight of the solvent-based pressure sensitive adhesive.

The term “hot-melt pressure sensitive adhesive composition” designates in the present disclosure solvent-free pressure sensitive adhesives, which are applied as a melt. The term “syrup pressure sensitive adhesive composition” refers to pressure sensitive adhesives having sufficiently low viscosity at normal room temperature due to the relative high proportion of monomers, which allows the application without heating of the adhesive.

According to one or more embodiments, the water- or solvent-based acrylic pressure sensitive adhesive composition comprises:
A1) 25-85 wt.-%, preferably 35-75 wt.-%, of the at least one acrylic polymer AP and
B1) 5-85 wt.-%, preferably 10-75 wt.-%, of water or at least one organic solvent, all proportions being based on the total weight of the water- or solvent-based acrylic pressure sensitive adhesive composition.

In addition to the at least one acrylic polymer AP, the water- or solvent-based acrylic pressure sensitive adhesive may further comprise one or more additional constituents including, for example, tackifying resins, waxes, and plasticizers as well as one or more additives, such as UV-light absorption agents, UV- and heat stabilizers, optical brighteners, pigments, dyes, and desiccants. Preferably, the total amount of such additional constituents and additives is not more than 35 wt.-%, more preferably not more than 25 wt.-%, most preferably not more than 15 wt.-%, based on the total weight of the water- or solvent-based acrylic pressure sensitive adhesive composition.

According to one or more embodiments, the pressure sensitive adhesive layer has been obtained by using an UV- or electron beam-curable acrylic pressure sensitive adhesive composition.

The term “UV-curable acrylic pressure sensitive adhesive composition” refers to acrylic pressure sensitive adhesives, which can be cured by initiation of photochemical curing reactions by UV-irradiation. The term “curing” in the present disclosure to chemical reactions comprising forming of bonds resulting, for example, in chain extension and/or crosslinking of polymer chains. The term “electron beam-curable acrylic pressure sensitive adhesive composition” refers in the present disclosure to acrylic pressure sensitive adhesives, which can be cured by initiation of curing reactions by electron beam irradiation.

According to one or more preferred embodiments, the pressure sensitive adhesive layer has been obtained by using an UV- or electron beam-curable acrylic hot-melt or syrup pressure sensitive adhesive composition, preferably of an UV-curable acrylic hot-melt or syrup pressure sensitive adhesive composition.

According to one or more embodiments, the UV-curable acrylic hot-melt pressure sensitive adhesive composition comprises:
A2) at least 65 wt.-%, preferably at least 75 wt.-%, of the at least acrylic polymer AP,
B2) 0-30 wt.-%, preferably 5-20 wt.-%, of the at least one tackifying resin TR,
C2) 0-5 wt.-%, preferably 0.01-1 wt.-%, of at least one cross-linking agent CA,
D2) 0.1-5 wt.-%, preferably 0.25-2.5 wt.-%, of at least one photoinitiator PI,
all proportions being based on the total weight of the UV-curable acrylic hot-melt pressure sensitive adhesive composition.

The at least one cross-linking agent CA is preferably a multifunctional acrylate selected from the group consisting of butanediol di(meth)acrylate, ethyleneglycol di(meth)acrylate, diethyleneglycol di(meth)acrylate, triethyleneglycol di(meth)acrylate, trimethylolpropane trimethacrylate, hexanediol diacrylate, trimethylolpropane triacrylate, and tripropyleneglycol diacrylate, trimethylolpropane ethoxy triacrylate, trimethylolpropane triacrylate, tripropylene glycol diacrylate, propylene glycol di(meth)acrylate, dipropylene glycol diacrylate, dipentaerythritol hydroxy pentaacrylate, neopentyl glycol propoxylate diacrylate, bisphenol A ethoxylate di(meth)acrylate, alkoxylated hexanediol diacrylate, ethoxylated bisphenol A diacrylate, ethoxylated bisphenol A di(meth)acrylate, ethoxylated trimethylolpropane triacrylate, propoxylated neopentyl glycol diacrylate, propoxylated glyceryl triacrylate, and polybutadiene di(meth)acrylate.

Suitable compounds for use as the at least one photoinitiator PI include free radical photo initiators and cationic photo initiators, especially free radical photo initiators. Suitable compounds for use as photoinitiators include, for example, benzoic ethers, dialkoxyacetophenones, alpha-hydroxycyclohexyl aryl ketones, alpha-ketophenylacetate esters, benzyldialkylketals, chloro- and alkylthioxanthones and alpha-amino- and alpha-hydroxyalkyl aryl ketones. Selection of the type of the at least one photoinitiator depends on the wavelength of the UV-radiation used for curing of the adhesive.

According to one or more embodiments, the at least one photoinitiator PI is a free radical photo initiator, which can be activated with UV-A irradiation, preferably with UVA-1 irradiation.

Preferred photoinitiators showing absorption in the UVA-1 irradiation wavelength range include so called Norrish type I initiators as well as some Norrish type II initiators.

Especially suitable Norrish type I photoinitiators include phospine oxides (PO), such as diphenyl(2,4,6-trimethylbenzoyl)phosphine oxide (TPO), ethyl phenyl(2,4,6-trimethylbenzoyl) phosphinate (TPO-L), phenylbis(2,4,6-trimethylbenzoyl)phosphine oxide (BAPO), bis-(2,6-dimethoxybenzoyl)-2,4,4-trimethylpentylphosphine oxide (BAPO-1), 2-benzyl-2-(dimethylamino)-4-morpholino-butyrophenone (BDMB), and phenyl-bis-(2,4,6-trimethylbenzoyl) phosphine oxide (BAPO-2). These are commercially available, for example, under the trade name of Omnirad (from IGM Resins), Genocure (from Rahn AG), Speedcure (from Lambson (part of Arkema), Songcure (from Songwon), and Photoinitiators from Bodo Möller Chemie.

Suitable Norrish type II photoinitiators include thiozanthones (TX), for example, 2-Isopropylthioxanthone (ITX), thioxanthone-anthracene (TX-A), 2,4-diethylthioxanthone (DETX), 2-Chlorothioxanthone (CTX), 2,4-Dimethylthioxanthone (RTX), 2,4-diisopropylthioxanthone (DITX), 1-Chloro-4-propoxythioxanthone (CPTX); polymeric TXs such as polymeric CPTX, polyTHF-di(thioxanthone-2-oxyacetate); and dl-camphorquinine 2,3-bornanedione (CQ). These are commercially available, for example, under the trade names of Genocure® (from Rahn GmbH), Omnirad® (from IGM resins), and SpeedCure® (from Lambson).

According to one or more embodiments, the at least one free radical photo initiator is a phosphine oxide based photoinitiator, preferably selected from the group consisting of diphenyl(2,4,6-trimethylbenzoyl)phosphine oxide (TPO), ethyl phenyl(2,4,6-trimethylbenzoyl) phosphinate (TPO-L), phenylbis(2,4,6-trimethylbenzoyl)phosphine oxide (BAPO), bis-(2,6-dimethoxybenzoyl)-2,4,4-trimethylpentylphosphine oxide (BAPO-1), and 2-benzyl-2-(dimethylamino)-4-morpholino-butyrophenone (BDMB).

Furthermore, the photoinitiators may be used in combination with synergists/activators that are well known to skilled person. The preferred type of the synergist depends on the type of the photoinitiator, for example the radical formation with Norrish type II initiators requires a hydrogen donor as a synergist. Examples of suitable synergists for the Norrish II initiators include, for example, amino benzoates, acrylated amines, and thiol compounds.

According to one or more further embodiments, the UV-curable acrylic hot-melt pressure sensitive adhesive composition comprises:
A3) At least 65 wt.-%, preferably at least 85 wt.-%, of at least one UV-curable acrylic polymer UV-AP having one or more photo initiator groups,
B3) 0-15 wt.-%, preferably 0.1-10 wt.-%, of at least one reactive diluent, and
C3) 0-20 wt.-%, preferably 1-15 wt.-%, of the at least one mineral filler MF, all proportions being based on the total weight of the UV-curable acrylic hot-melt pressure sensitive adhesive composition.

The at least one UV-curable acrylic polymer UV-AP comprises polymerized units that serve as photoinitiators. Suitable polymerized units that serve as photo initiators may be obtained by using copolymerizable photo initiators, such as acetophenone and benzophenone derivatives.

According to one or more embodiments, the at least one UV-curable acrylic polymer UV-AP comprises 0.05-10 wt.-%, preferably 0.1-5 wt.-%, more preferably 0.1-1.5 wt.-%, based on the weight of the polymer UV-AP, of at least one ethylenically unsaturated compound having a photo initiator group.

Suitable UV-curable acrylic hot-melt pressure sensitive adhesives are commercially available, for example, under the trade name of acResin® (from BASF); under the trade name of AroCure® (form Ashland Chemical); and under the trade name of NovaMeltRC® (from Henkel).

According to one or more embodiments, the UV-curable acrylic syrup pressure sensitive adhesive composition comprises:
A4) at least 35 wt.-%, preferably at least 50 wt.-%, of the at least acrylic monomer AM,
B4) 0-30 wt.-%, preferably 5-20 wt.-%, of the at least one tackifying resin TR,
C4) 0-5 wt.-%, preferably 0.01-1 wt.-%, of the at least one cross-linking agent CA, and
4) 0.1-5 wt.-%, preferably 0.25-2.5 wt.-%, of the at least one photoinitiator PI, all proportions being based on the total weight of the UV-curable acrylic syrup pressure sensitive adhesive composition.

According to one or more further embodiments, the UV-curable acrylic syrup pressure sensitive adhesive composition comprises:
A51) at least 35 wt.-%, preferably at least 50 wt.-%, more preferably at least 55 wt.-%, even more preferably at least 65 wt.-%, of at least acrylic compound A,
A52) 1.5-55 wt.-%, preferably 2.5-45 wt.-%, more preferably 5-40 wt.-%, even more preferably 7.5-35 wt.-%, of a reaction product RP obtained by polyaddition reaction of at least one compound P with at least one hardener H,
B5) 0-30 wt.-%, preferably 5-20 wt.-%, of the at least one tackifying resin TR,
C5) 0-5 wt.-%, preferably 0.01-1 wt.-%, of the at least one cross-linking agent CA, and
D6) 0.1-5 wt.-%, preferably 0.25-2.5 wt.-%, of the at least one photoinitiator PI, all proportions being based on the total weight of the UV-curable acrylic syrup pressure sensitive adhesive.

Examples of suitable acrylic compounds A for use in the UV-curable acrylic syrup pressure sensitive adhesive include acrylic monomers, such as (meth)acrylates, alkyl(meth)acrylates, di(meth)acrylates, and derivatives thereof, for example, amides and nitriles of (meth)acrylates. Further suitable acrylic compounds A include (meth)acryl-functional polymers, such as (meth)acrylate, polyurethane, polyether/polyoxyalkylene, and polyester polymers containing one or more (meth)acryl groups. The (meth)acryl groups of an (meth)acryl-functional polymer may be in pendant positions in the polymer chain or in terminal positions.

According to one or more embodiments, the at least one acrylic compound A contains exactly one acryl group.

Preferably, the at least one acrylic compound A has a weight average molecular weight (M_{w}) of not more than 25000 g/mol, more preferably not more than 15000 g/mol, even more preferably not more than 10000 g/mol.

According to one or more embodiments, the at least one acrylic compound A has a weight average molecular weight (M_{w}) in the range of 100-15000 g/mol, preferably 125-10000 g/mol, more preferably 125-7500 g/mol, even more preferably 125-5000 g/mol and/or a viscosity at 20° C. determined according to ISO 3219:1994 standard in the range of 250-25000 mPa·s, preferably 500-20000 mPa·s, more preferably 1000-15000 mPa·s, even more preferably 1500-15000 mPa·s.

As used in the present disclosure, the term “polyaddition reaction” refers to a reaction in which new bonds are formed by undergoing an addition reaction among functional groups of the compound having a functional group and the aforesaid reaction is successively repeated to form a polymer. Consequently, the at least one compound P contains first type of functional group(s) that that react with second type of functional group(s) contained in the at least one hardener H in the polyaddition reaction.

According to one or more embodiments, the at least one compound P contains isocyanate groups, i.e. the first type of functional groups of the at least one compound P are isocyanate groups and the at least one hardener contains isocyanate-reactive groups, i.e. the second type of functional groups of the at least one hardener H are isocyanate-reactive groups.

According to one or more embodiments, the polyaddition reaction between the at least one compound P and the at least one hardener H is conducted at a molar ratio of the isocyanate groups to the isocyanate-reactive groups of 0.95-1.5, preferably 0.97-1.2, more preferably 0.97-1.1, even more preferably 0.97-1.05.

In one embodiment, the adhesive tape (1) further comprises a release liner (5) covering an outer major surface of the pressure sensitive adhesive layer (4) facing away from the polymeric support layer (3).

The release liner is typically used to prevent premature unwanted adhesion and to protect the pressure sensitive adhesive layer from moisture, fouling, and other environmental factors. In case the sealing element is provided in form of rolls, the release liner enables ease of unwind without sticking of the adhesive to the back side of the sealing device. The release liner may be sliced into multiple sections to allow portioned detachment of the liner from the pressure sensitive adhesive layer.

Suitable materials for the release liner include Kraft paper, polyethylene coated paper, silicone coated paper as well as polymeric films, for example, polyethylene, polypropylene, and polyester films coated with polymeric release agents selected from silicone, silicone urea, urethanes, waxes, and long chain alkyl acrylate release agents.

The preferences given above for the metal film, polymeric support layer, pressure sensitive adhesive layer, and the release liner apply equally to all aspects of the present invention unless otherwise stated.

Another aspect of the present invention is a method for producing an adhesive tape, the method comprising steps of:
I) Providing a composite element comprising a metal film (2) laminated to a polymeric support layer (3),
II) Applying a pressure sensitive adhesive layer (4) on the second major surface of the polymeric support layer (3) facing away from the metal film (2), and
III) Optionally covering an outer major surface of the pressure sensitive adhesive layer (4) facing away from the polymeric support layer (3) with a release liner (5).

In one embodiment, the metal film (2) is adhesively laminated to the polymeric support layer. Such composite elements can be obtained by using conventional laminating techniques that are known to the skilled person.

The further details of the method for producing the adhesive tape depend on the embodiment of the tape, particularly on the type of the pressure sensitive adhesive.

In case a water- or solvent-based pressure sensitive adhesive composition is used for providing the pressure sensitive adhesive layer (4), step II) of the method can comprise:
applying the water- or solvent-based pressure sensitive adhesive composition as a wet adhesive film to the second major surface of the polymeric support layer (2) and
drying the wet adhesive film by allowing the volatile components to evaporate, or
applying the water- or solvent-based pressure sensitive adhesive composition as a wet adhesive film to a surface of transfer sheet,
at least partially drying the wet adhesive film by allowing at least a portion of the volatile components to evaporate, and
transferring the at least partially dried adhesive film to the second major surface of the polymeric support layer (2).

In case a hot-melt pressure sensitive adhesive composition is used for providing the pressure sensitive adhesive layer (4), step II) of the method may comprise:
heating the hot-melt pressure sensitive adhesive composition to allow the composition to flow and
applying the heated hot-melt pressure sensitive adhesive composition as an adhesive film to the second major surface of the polymeric carrier layer (2)
   or
heating the hot-melt pressure sensitive adhesive composition to allow the composition to flow,
applying the heated hot-melt pressure sensitive adhesive composition as an adhesive film to a surface of transfer sheet, and
transferring the adhesive film to the second major surface of the polymeric support layer (2).

It may be preferred that the hot-melt acrylic pressure sensitive adhesive composition is heated to a temperature in the range of 60-250° C., such as 70-225° C., particularly 80-200° C.

In case a UV- or electron beam-curable pressure sensitive adhesive composition is used for providing the pressure sensitive adhesive layer (4), step II of the method can comprise:
applying the UV- or electron beam-curable pressure sensitive adhesive composition as an adhesive film to the second major surface of the polymeric support layer (2) and
at least partially curing the adhesive film by subjecting the adhesive film to UV- or electron beam radiation, or
applying the UV- or electron beam-curable pressure sensitive adhesive composition as an adhesive film to a surface of transfer sheet,
at least partially curing the adhesive film by subjecting the adhesive film to UV- or electron beam radiation, and
transferring the at least partially cured adhesive film to the second major surface of the polymeric support layer (2).

An adhesive composition may be applied to a surface of the polymeric support layer (2) or to a surface of a transfer sheet by using any conventional techniques such as slot die coating, extrusion coating, roller coating, direct gravure coating, offset gravure coating, reverse gravure roll-coating, powder dispersion, or spray lamination techniques.

In one embodiment, the method for producing an adhesive tape comprises a further step IV) of winding the composite element obtained in step II) or III) into a roll.

Another aspect of the present invention is a method for fireproofing a substrate (6), the method comprising steps of:
I. Providing an adhesive tape (1) according to the present invention,
II. Applying the adhesive tape (1) onto a surface of the substrate (6) such that at least a portion of the outer major surface of the pressure sensitive adhesive layer (4) is directly connected to the surface of the substrate (6), and
III. Pressing the adhesive tape (1) against the surface of the substrate (6) with a pressure sufficient to affect adhesive bonding between the adhesive tape (1) and the surface of the substrate (6).

The adhesive tape is typically provided in form of a roll and cut to a suitable length before being applied onto the surface of the substrate. In case the adhesive tape comprises a release liner, it is removed before the sealing element is applied onto the surface of the substrate.

It may be preferred, although not necessary, that the surface of the substrate is pre-treated by chemical and/or physical cleaning methods, such as de-greasing or brushing and/or by the application of an adhesion promoter, an adhesion promoter solution or a primer before the application of the adhesive tape. In general, it is not necessary to pre-treat the surface of the substrate by the application of an adhesion promoter, an adhesion promoter solution or a primer.

To secure sufficient bonding of the polymeric support layer (2) onto the surface of the substrate (6), the adhesive tape (1) can be pressed against the surface of the substrate (6), for example, by using a roller or a scraper.

In one embodiment, the substrate to be fireproofed is a roof substrate, preferably comprising plastic or metal, preferably selected from membrane, roof deck, insulation board, or cover board.

Still another aspect of the present invention is a fireproofed structure obtained by using the method as discussed above.

The fireproofed structure comprises an adhesive tape (1) according to the present invention and a substrate (6), wherein at least a portion of the second major surface of the polymeric support layer (2) is bonded to the surface of the substrate (6) via the pressure sensitive adhesive layer (4).

### EXAMPLES

### Preparation of Test Specimens

The exemplary adhesive tape had the following basic buildup:
i) A metal film having a thickness of 50 μm,
ii) A polymeric support layer having a thickness of 23 μm, and
iii) A pressure sensitive adhesive layer having a thickness of 0.5 mm.

The adhesive tape was prepared by adhesively laminating the metal film to a first surface of the polymeric support layer followed by applying the pressure sensitive adhesive layer to a second surface of the polymeric carrier layer facing away from the metal film.

The thus obtained adhesive tape was then tested the fire resistance properties.

The pressure sensitive adhesive was a butyl-based adhesive, which is commercially available from Isocoll Chemie CmbH.

### Fire Resistance

The test for fire was conducted according to EN 13501-5 standard and the adhesive tape was found to fulfill the requirements for Broof(t1) classification for external fire performance.

1. An adhesive tape comprising:
i) a metal film having first and second major surfaces and a thickness of not more than 100 μm,
ii) a polymeric support layer having first and second major surfaces,
iii) a pressure sensitive adhesive layer, and
iv) optionally a release liner covering an outer major surface of the pressure sensitive adhesive layer facing away from the polymeric support layer,
wherein the polymeric support layer is arranged between the metal film and the pressure sensitive adhesive layer.

2. The adhesive tape according to claim 1, wherein the metal film has a thickness of 10-100 μm.

3. The adhesive tape according to claim 1, wherein the metal film is an aluminum film.

4. The adhesive tape according to claim 1, wherein the polymeric support layer has a thickness of not more than 100 μm.

5. The adhesive tape according to claim 1, wherein the polymeric support layer comprises at least one polymer selected from polyethylene, polyethylene terephthalate, and polyamide.

6. The adhesive tape according to claim 5, wherein the at least one polymer is present in the polymeric support layer in an amount of at least 50 wt.-%, based on the total weight of the polymeric support layer.

7. The adhesive tape according to claim 5, wherein the at least one polymer is polyethylene terephthalate.

8. The adhesive tape according to claim 1, wherein the metal film and the polymeric support layer are indirectly connected to each other over at least a portion of their opposing major surfaces, wherein the metal film covers at least 50% of the area of the first major surface of the polymeric support layer.

9. The adhesive tape according to claim 1, wherein the first major surface of the metal film forms one of the primary exterior surfaces of the adhesive tape.

10. The adhesive tape according to claim 1, wherein the pressure sensitive adhesive layer has a thickness of not more than 1.5 mm.

11. The adhesive tape according to claim 1, wherein the pressure sensitive adhesive is selected from the group consisting of synthetic rubber-, natural rubber-, and bitumen-based pressure sensitive adhesives, and acrylic pressure sensitive adhesives.

12. The adhesive tape according to claim 1, wherein the pressure sensitive adhesive is a butyl rubber-based pressure sensitive adhesive.

13. The adhesive tape according to claim 12, wherein the butyl rubber-based pressure sensitive adhesive comprises:
A) 15-75 wt.-% of butyl rubber BR,
B) 1-65 wt.-% of at least one tackifying resin TR,
C) 0-35 wt.-%, of at least one mineral filler MF, and
D) 0-30 wt.-% of at least one plasticizer PL, all proportions being based on the total weight of the butyl rubber-based adhesive.

14. A method for producing an adhesive tape according to claim 1, the method comprising steps of:
I) providing a composite element comprising a metal film laminated to a polymeric support layer,
II) applying a pressure sensitive adhesive layer on the second major surface of the polymeric support layer facing away from the metal film, and
III) optionally covering an outer major surface of the pressure sensitive adhesive layer facing away from the polymeric support layer with a release liner.

15. A method for fireproofing a substrate, the method comprising steps of:
I. providing an adhesive tape according to claim 1,
II. applying the adhesive tape onto a surface of the substrate such that at least a portion of the outer major surface of the pressure sensitive adhesive layer is directly connected to the surface of the substrate and
III. pressing the adhesive tape against the surface of the substrate with a pressure sufficient to affect adhesive bonding between the adhesive tape and the surface of the substrate.

16. The method according to claim 15, wherein the substrate is a roof substrate.
